(19) United States
(12) Patent Application Publication
(10) Pub. No.: US 2016/0263593 A1
(43) Pub. Date: Sep. 15, 2016

(54) ADJUSTABLE SMOOTH BORE NOZZLE

(71) Applicant: Akron Brass Company, Wooster, OH (US)

(72) Inventor: Brian E. Keim, Wooster, OH (US)

(73) Assignee: Akron Brass Company, Wooster, OH (US)

(21) Appl. No.: 15/066,427

(22) Filed: Mar. 10, 2016

Related U.S. Application Data
(60) Provisional application No. 62/130,781, filed on Mar. 10, 2015.

(51) Int. Cl. B05B 1/30; B05B 7/04; B05B 1/02; B05B 1/34

(52) U.S. Cl. CPC B05B 1/30; B05B 1/34; B05B 7/0425; B05B 1/02

(57) ABSTRACT

One or more techniques and/or systems are disclosed for a nozzle that may allow the operator to adjust the flow rate of the fluid through a straight stream nozzle, while maintaining an open waterway. A nozzle may be devised that utilizes an adjustment motion common to operators of such a nozzle, where the adjustment motion allows the operator to switch between a fully open flow and a restricted flow. The fully open flow can provide a smooth bore straight profile stream of fluid at a higher flow rate, and the restricted flow can provide the smooth bore straight profile stream at a lower flow rate.

### CROSS-REFERENCE TO RELATED APPLICATIONS

This application claims priority to U.S. Provisional Patent Application Ser. No. 62/130,781, entitled ADJUSTABLE SMOOTH BORE NOZZLE, filed Mar. 10, 2015, which is incorporated herein by reference.

### BACKGROUND

Current smooth bore nozzles can provide a straight fluid stream. Typically, when a user wishes to alter a flow rate of fluid discharge from a nozzle, a stacked tip assembly is used. The stacked tip assembly utilizes a series of nozzle tips, of varying sizes, stacked in sequence to achieve a desired flow rate and discharge stream profile. The user typically shuts off the fluid supply, and one or more tips are removed and/or added to achieve the desired assembly. The resulting nozzle assembly can provide the desired straight stream profile, with the desired fluid discharge rate, and achieve a desired stream reach.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, a fluid dispensing nozzle that can allow the operator to adjust a flow rate (e.g., in gallons or liters per minute) of the fluid dispensed from the nozzle, while maintaining a flow of fluid through the nozzle. That is, for example, the flow rate and/or stream profile may be adjusted without shutting down the fluid flow through the nozzle. A nozzle may be devised that utilizes an adjustment motion common to operators of such a nozzle, where the adjustment motion allows the operator to switch between an open flow and a restricted flow. The open flow can provide a smooth bore, straight stream profile of fluid at a higher flow rate, and the restricted flow can provide the smooth bore, straight stream profile at a lower flow rate.

In one implementation, a nozzle can comprise a nozzle base that may be configured to operably couple a fluid flow control body with a nozzle tip. The nozzle base can comprise a base fluid passage, where the base fluid passage is defined by a cylinder having a first shape at its downstream, and a second shape at its upstream face. The nozzle tip can comprise a tip fluid passage that comprises an inlet face substantially similar to the first shape; and the base fluid passage can fluidly couple with the tip fluid passage to form a nozzle fluid passage. The nozzle tip or the nozzle base can be configured to rotate around a central axis of the nozzle between a passage alignment configuration and a passage non-alignment configuration, where the central axis of the nozzle is substantially parallel to the flow of fluid.

In another implementation, a nozzle can comprise a nozzle base, which may comprise a base fluid passage defined by a cone-shaped passage, diverging in the direction of fluid flow. The nozzle base can be configured to selectably couple with a fluid flow control body and a nozzle tip. The nozzle tip can be configured to separate fluid flow from the nozzle base into an outer fluid stream and a central fluid stream, and subsequently merge the separated streams into a substantially straight stream pattern at a nozzle outlet portion. The nozzle tip can comprise a stream separator configured to separate the fluid flow into the outer fluid stream and central fluid stream. Further, the nozzle tip can comprise a discharge tube that is selectably coupled with the stream separator and configured to direct the central fluid flow to the fluid outlet. The shape of the outside surface of the discharge tube, in combination with an inner wall of the nozzle tip, can direct the outer fluid stream to a convergent path with the central fluid stream. Additionally, the nozzle tip can comprise a flow control sleeve that can be configured to translate between a forward and rearward position. The flow control sleeve can comprise a restrictor configured to restrict the outer fluid stream in conjunction with the outside surface of the discharge tube in the rearward position, and provide a substantially unrestricted outer fluid stream flow in the forward position.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating a side view of an example implementation of a nozzle.

FIG. 2 is a component diagram illustrating a cross section side view of another example implementation of a nozzle, in accordance with one or more systems described herein.

FIG. 3 is a component diagram illustrating another cross section bottom view of an example implementation of a portion of a nozzle, in accordance with one or more systems described herein.

FIG. 4 is a component diagram illustrating another cross section side view of an example implementation of a portion of a nozzle, in accordance with one or more systems described herein.

FIG. 5 is a component diagram illustrating another cross section bottom view of an example implementation of a portion of a nozzle, in accordance with one or more systems described herein.

FIGS. 6A and 6B are component diagrams illustrating a front, discharge end view of an example implementation of a portion of a nozzle, in accordance with one or more systems described herein.

FIG. 7 is a component diagram illustrating another cross section bottom view of an example implementation of a portion of a nozzle, in accordance with one or more systems described herein.

FIGS. 8A and 8B are component diagrams illustrating a perspective view of an example implementation of one or more portions of a nozzle, in accordance with one or more systems described herein.

FIG. 9 is a component diagram illustrating a side view of an example implementation of another nozzle.

FIG. 10 is a component diagram illustrating a cross section side view of an example implementation of another nozzle, in accordance with one or more systems described herein.

FIG. 11 is a component diagram illustrating a cross section side view of an example implementation of another nozzle, in accordance with one or more systems described herein.

FIG. 12 is a component diagram illustrating a cross section side view of an example implementation of another nozzle, in accordance with one or more systems described herein.

FIG. 13 are component diagrams illustrating a perspective, cut-away view of an example implementation of one or more portions of a nozzle, in accordance with one or more systems described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

A nozzle may be devised that comprises a straight bore stream pattern fluid outlet, which can be adjusted between different fluid flow rates, while maintaining a fluid flow through the nozzle and discharging in a straight stream profile. That is, for example, fluid flow through the nozzle may not need to be shut down in order to adjust the fluid flow rate, and one or more stacked tips may not need to be removed or added. Further, the nozzle may allow a user to switch between different flow rates using a single motion that is common to users of such a nozzle (e.g., firefighters), such as a rotation of a portion of the nozzle, such as the nozzle tip or base.

In one aspect, a portion of the fluid passage through the nozzle may comprises a non-circular shape, which, when adjusted (e.g., rotated) into a non-alignment position, can result in a restricted fluid flow through the passage. The nozzle base can comprise a base fluid passage that is defined by a cylinder having a first shape (e.g., a polygon, such as a triangle, square, pentagon, etc., a curved polygon, or ellipse (non-circle)) at its downstream face (e.g., end), and a second shape (e.g., ellipse, such as a circle) at its upstream face. Further, the nozzle can comprise the nozzle tip that may be configured to operably couple with the nozzle base. The nozzle tip can comprise a tip fluid passage that has an inlet face (e.g., at its upstream end) substantially similar to the first shape; and the base fluid passage can fluidly couple with the tip fluid passage to form the nozzle fluid passage.

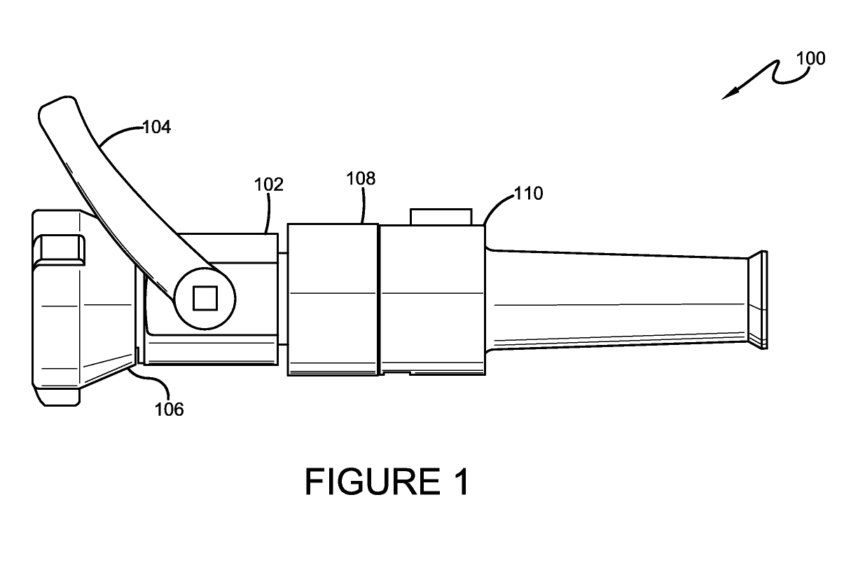

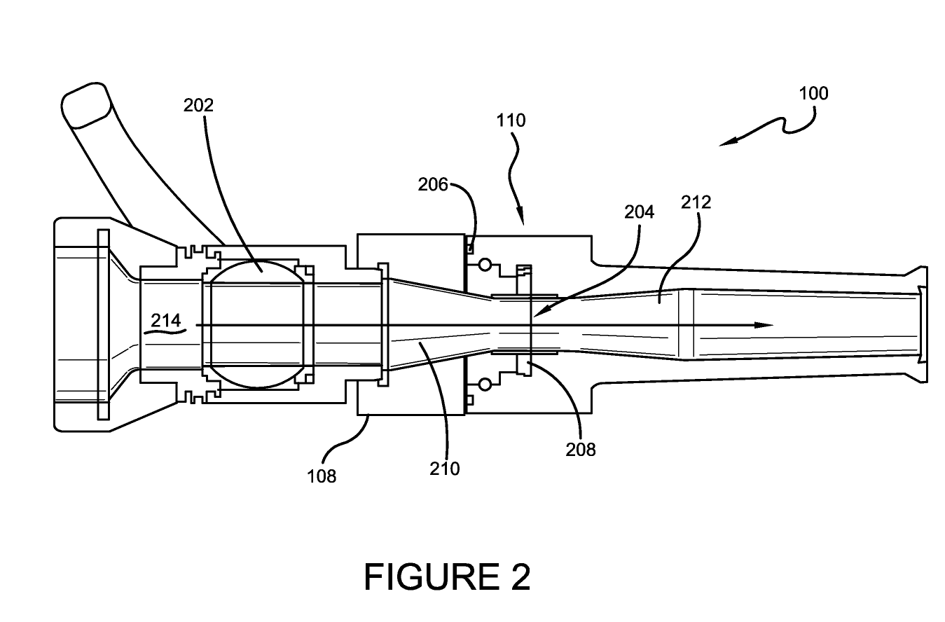

In one implementation, in this aspect, as illustrated in FIGS. 1 and 2, an example nozzle 100 can comprise a fluid flow control body 102 configured to control fluid flow into the nozzle. The fluid flow control body 102 can comprise a control actuator 104, that is operably coupled to a fluid flow control element 202. The fluid flow control element 202 is configured to control a flow of fluid 214 into the nozzle 100. In this implementation, the fluid flow control body 102 is fluidly coupled with a fluid inlet 106. The control actuator 104 can be configured to control the fluid flow control element 202, for example, by controlling an amount of rotation of the fluid flow control element 202. In one implementation, the control actuator 104 may be used to restrict fluid flow 214 (e.g., shut off fluid flow) to the nozzle 100, or open fluid flow 214 to the nozzle 100. In another implementation, the control actuator 104 may cause the flow of fluid 214 to be reduced through the nozzle 100, for example, by throttling the control actuator 104 between an open and closed position.

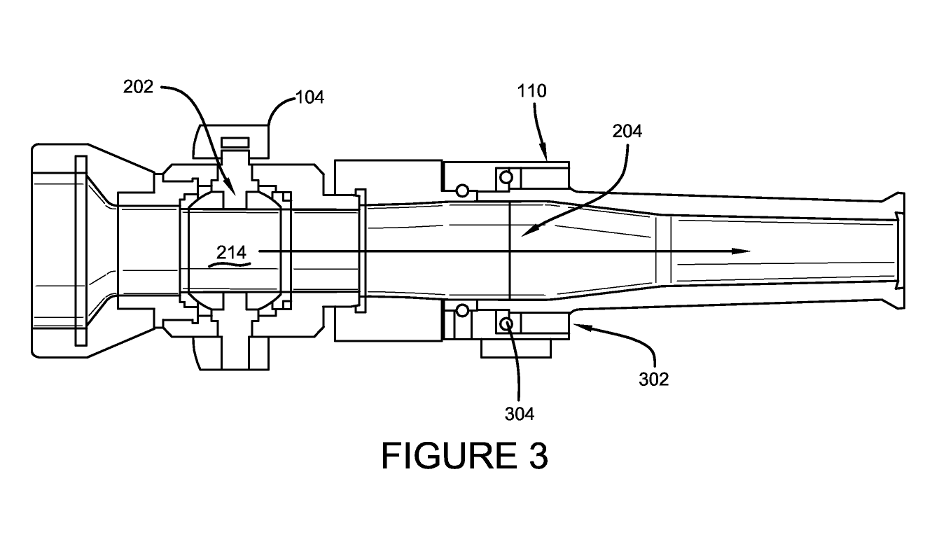

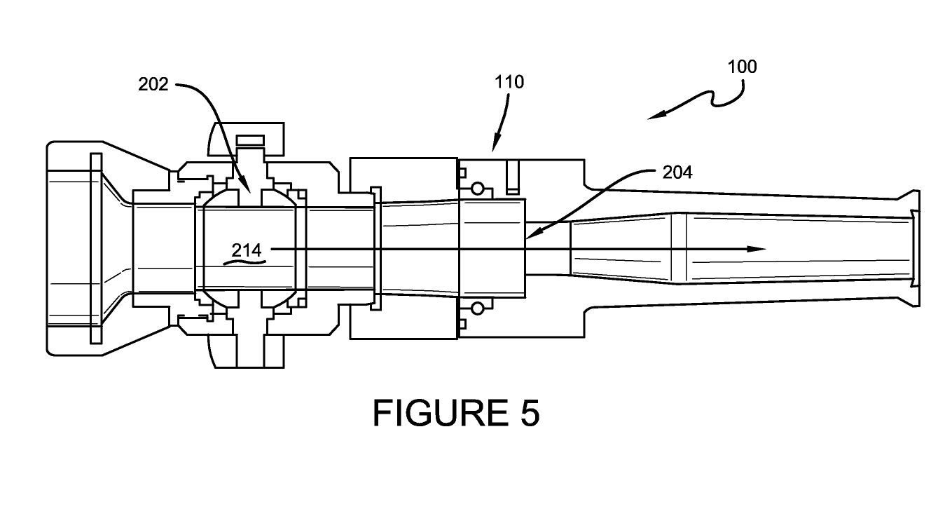

As a non-limiting example, a flow control element (e.g., 202) may comprise one of the following types: a ball, butterfly, slide, piston, plug, globe, check, gate, and others. The flow control element 202 may take any form chosen in accordance with sound engineering judgment to stop, mitigate, reduce, or decrease fluid flow 214. In one implementation, the fluid flow control element 202 may comprise a ball-type flow control element (“ball”). In this implementation, for example, a ball can be disposed proximate the fluid inlet 106 to the nozzle 100, as illustrated in FIGS. 2-5, illustrating an example flow shutoff ball, shown in the open position (e.g., allowing fluid to flow into the nozzle).

In one implementation, as illustrated in FIGS. 1, 2, 3, 4, and 5, an example nozzle 100 can comprise a nozzle base 108 and a nozzle tip 110. The nozzle base 108 can be configured to selectably, operably couple with the fluid flow control body 102 and the nozzle tip 110. For example, the nozzle base 108 may comprise a type of adaptor between the fluid flow control body 102 and the nozzle tip 110. In another implementation, the nozzle tip may be configured to selectably, operably couple directly with the fluid flow control body 102, for example, without utilizing the nozzle base 108.

The nozzle base 108 can comprise a base fluid passage 210, and the nozzle tip 110 can comprise a tip fluid passage 212. The nozzle tip fluid passage 212 can be configured to provide a smooth bore (e.g., smooth bore tip), fluid pattern at discharge of the fluid from the nozzle, which may provide a generally straight pattern stream of fluid from the outlet of the nozzle. As an example, the straight bore portion of the example nozzle 100 can comprise a generally straight tube configured to provide a substantially straight path for fluid from inside the nozzle to an outlet portion of the nozzle. In this way, pressurized fluid can be expelled from the nozzle in a generally straight stream pattern.

A location where the base fluid passage 210 meets the tip fluid passage 212 may form an interface orifice area 204, which may act as a restrictor component. The interface orifice area 204 can comprise an area where the outlet of the base fluid passage 210 meets the inlet for the tip fluid passage 212. In one implementation, a shape and size of the interface orifice area 204 can be defined by a relationship between the base fluid passage 210 and the tip fluid passage 212. In one implementation, a shape of a cylinder section defined by a plane intersecting the fluid passages 210, 212 at the orifice area 204, and perpendicular to the axis of the fluid passages 210, 212, can comprise a geometric shape that is not a circle, such as a polygon or ellipse. That is, for example, the shape of the intersecting plane at the interface orifice area 204 can comprise an ellipse, some type of polygon (e.g., triangle), or a curved polygon.

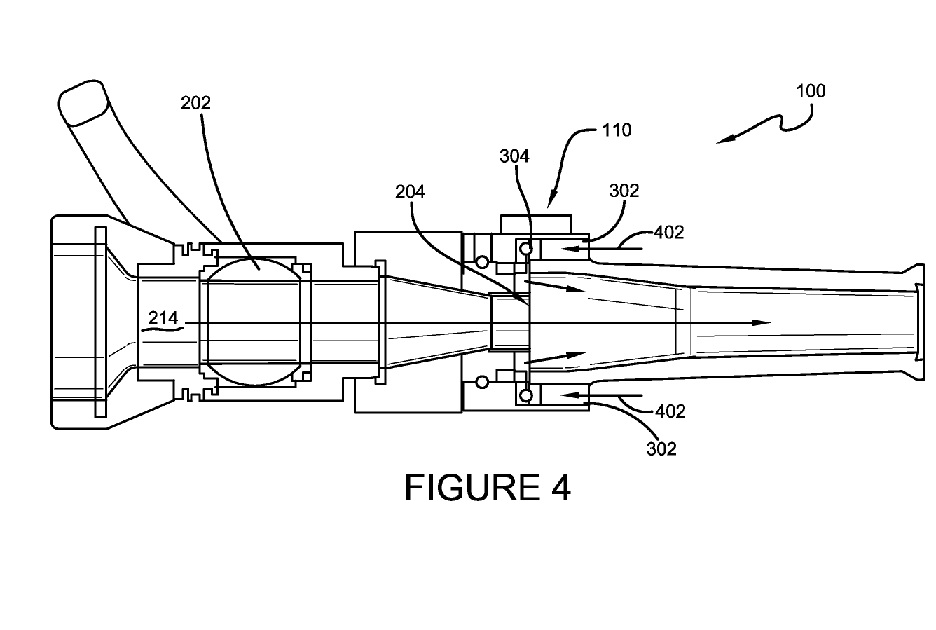

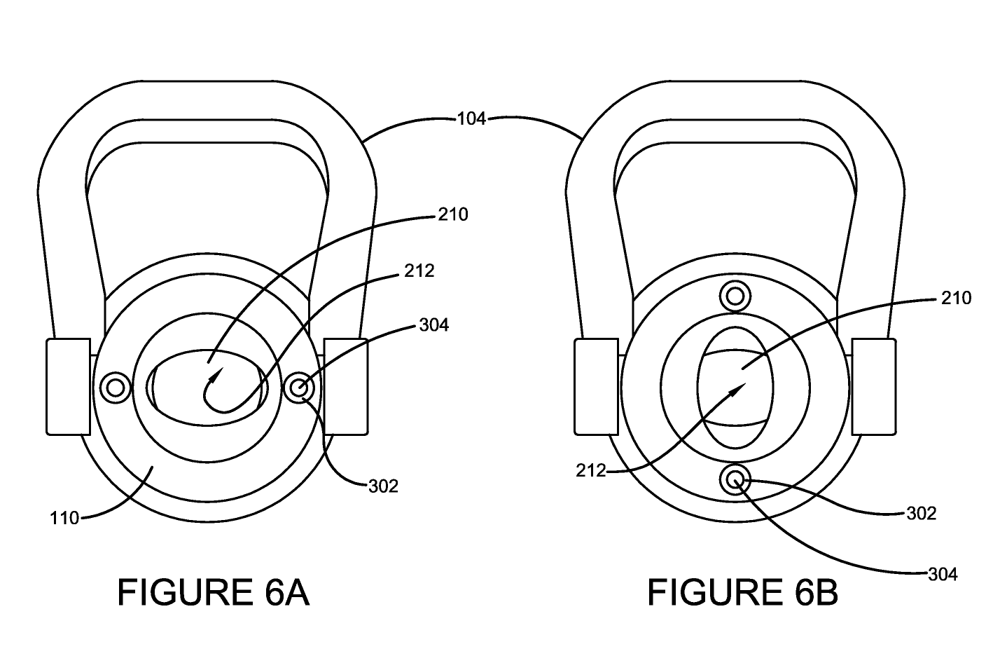

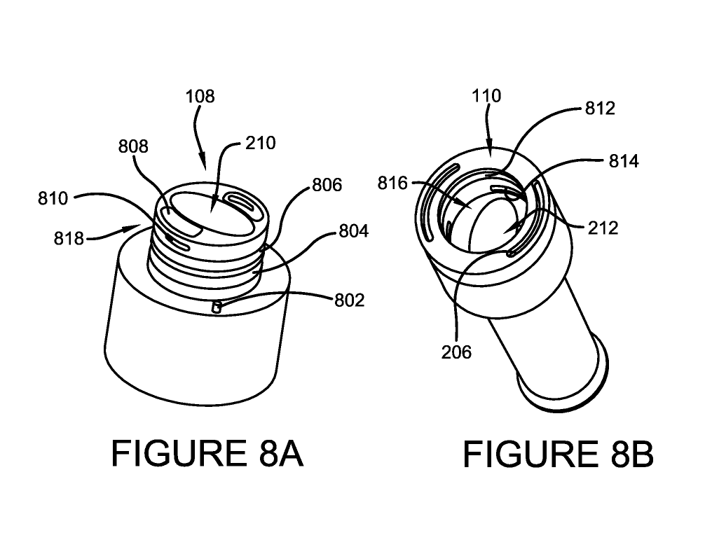

In one implementation, as illustrated in FIG. 8, the interface orifice area 204 end of the respective fluid passages 210, 212 (e.g., the downstream face of the nozzle base 108, and the upstream face of the nozzle tip 110, respectively) can comprise an ellipse. In this implementation, as illustrated in FIGS. 2, 3, 6A, and 7, when the interface orifice area 204 end of the respective fluid passages 210, 212 are aligned in an alignment position, such as when the major axes of the two ellipses are aligned, the passages 212, 210 can provide a higher rate of fluid flow 214, for example, without substantial restriction. As illustrated in FIGS. 4, 5, and 6B, when the interface orifice area 204 end of the respective fluid passages 210, 212 are not aligned in a non-alignment position, such as where the major axes of the respective ellipses are perpendicular to each other, the interface orifice area 204 is restricted, acting as a restrictor component, and providing a restricted fluid flow 214, thereby providing a lower flow rate for the nozzle.

In one implementation, the nozzle tip 110 can be rotated (e.g., around a central axis that is substantially parallel to the fluid flow 214) between a non-restricted and restricted configuration, acting as a restriction actuator for the restriction component—the interface orifice area 204. As one example, where the interface orifice area 204 comprises an ellipse in a non-restricted (e.g., unrestricted) configuration, the nozzle tip 110 can be configured to be rotated approximately ninety degrees (90°). In this example, rotating the nozzle tip 110 ninety degrees can dispose the interface orifice area 204 ends of the respective fluid passages 210, 212 between an alignment position (e.g., where the major axes of the ellipses are aligned), and a non-alignment position (e.g., where the major axes of the ellipses are perpendicular), thereby restricting fluid flow 214.

In another implementation, where the interface orifice area 204 comprises a triangle (e.g., or curve-sided triangle) in a non-restricted (e.g., unrestricted) configuration, the nozzle tip 110 can be configured to be rotated approximately sixty degrees (60°). In this implementation, rotating the nozzle tip sixty degrees can change the interface orifice area 204 between a non-restricted position, having unrestricted flow, and a restricted position, having restricted flow. Further, as another implementation, the interface orifice area 204 comprises a square (e.g., or curved square), which can be rotated approximately forty-five degrees; or a six-sided polygon (or some other polygon), which can be rotated thirty degrees. In yet another implementation, the nozzle base 108 may be configured to be rotated, relative to the nozzle tip 110, thereby acting as the restriction actuator, acting upon the interface orifice area 204. In this implementation, as described above, rotating the nozzle base 108 can dispose the orifice area 204 ends of the respective fluid passages 210, 212 between an alignment position, and a non-alignment position, thereby restricting fluid flow 214.

It will be appreciated that the shape and size of the faces of the passages 210, 212 on the transecting plane at the interface orifice area 204, formed by the meeting of the base fluid passage 210 and the tip fluid passage 212, is not limited to the examples described herein. It is anticipated that those skilled in the art may configure alternate shapes, such as non-regular shapes, which may be used in a similar manner. The shape and size of the interface orifice area 204 is merely used to describe how rotation of the nozzle tip 110 (e.g., and/or base 108) can result in the geometric alignment of the respective fluid passages 210, 212 to become misaligned, thereby providing a restricted flow through the nozzle; and where realigning the fluid passages' 210, 212 openings can provide for open flow.

In one implementation, as illustrated in FIGS. 2, 8A, and 8B, the nozzle tip 110 can comprise a rotation restrictor channel 206 disposed on a proximal (e.g., upstream) face. The rotation restrictor channel 206 can be configured to operably couple with a rotation restrictor pin 802 disposed on a distal (e.g., downstream) face of the nozzle base 108. Further, a length of the rotation restrictor channel 206 may determine an amount of rotation available for the nozzle tip 110 (e.g., or the nozzle base 108). That is, for example, the length of the rotation restrictor channel 206 can be configured to provide the desired amount of rotation (e.g., ninety, sixty, forty-five, thirty degrees, etc.), based on the geometry of the interface orifice area 204 ends of the respective fluid passages 210, 212.

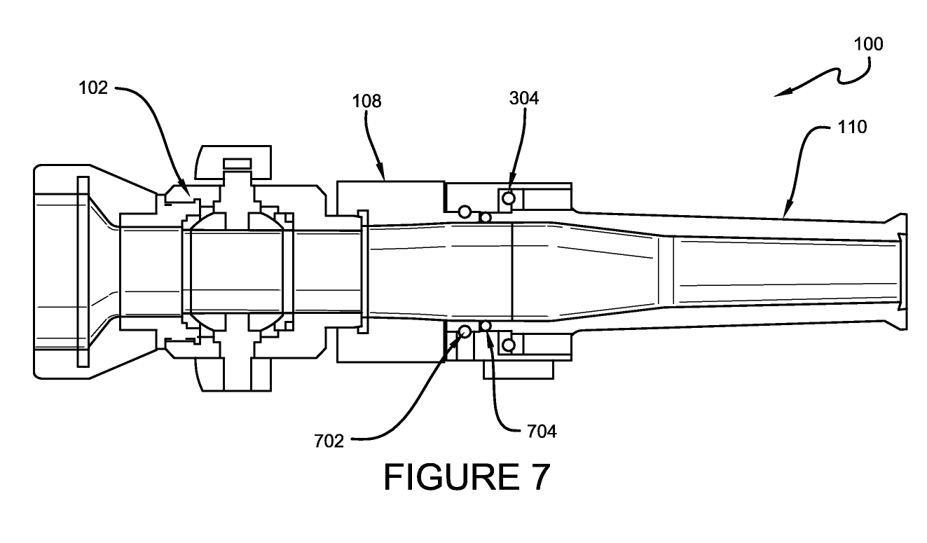

In one implementation, as illustrated in FIGS. 7, 8A, and 8B, the example nozzle tip 110 may operably couple with the nozzle base 108 by way of a bearing system. As an example, the nozzle tip 110 may comprise a bearing raceway 812, disposed on an inner surface of a coupling portion 816 of the tip 110. Further, the nozzle base 108 may comprise a bearing raceway 804 disposed on an outer surface of a coupling portion 818 of the base 108. Additionally, in one implementation, one or more ball bearings 702 may be disposed in the respective raceways 804, 812 when the base 108 is coupled with the tip 110. In one implementation, for example, nozzle 100 may comprise one or more O-rings 704, such as disposed between the base 108 and tip 110, where the respective coupling portions 816, 818 couple together. As an example, the O-ring 704 may be disposed in an O-ring channel 806, such as disposed in/on one or more of the respective coupling portions 816, 818.

In one implementation, as illustrated in FIGS. 2, 3, 4, 6A, 6B, 7 and 8, the example nozzle 100 can comprise an air inlet 302, which may be configured to allow air to enter the nozzle 100 when the nozzle 100 is disposed in a restricted configuration (e.g., FIG. 4). For example, when the nozzle tip 110 (e.g., or base) is rotated such that the shaped (e.g., first shape) downstream face of the base fluid passage 210 and upstream face of the tip fluid passage 212 are not in the alignment position (e.g., non-alignment position in a restricted configuration, as in FIGS. 4, 5, and 6B), outside air may enter through the air inlet 302 and become entrained into the fluid flow 214 in the tip fluid passage 212. In this implementation, introducing air into the tip fluid passage 212, such as at the upstream end of the tip fluid passage 212, may help mitigate turbulence that could result from a vacuum created eddy, which can strip water away from the center stream profile. That is, for example, instead of water trying to fill a void created by the misalignment of the geometric fluid passages 210, 212, the introduction of air can help maintain a desired center stream profile, resulting in an improved divergent fluid stream at the outlet of the nozzle.

For example, the nozzle tip 110 can comprise an intake air inlet 302 that is fluidly coupled with an air check valve 304 configured to merely allow air to flow into the nozzle tip 110, and mitigate flow of fluid out of the air inlet 302 (e.g., a one-way check valve). As illustrated in FIGS. 4, 8A and 8B, the nozzle tip can comprise an air passage 814, that is fluidly coupled with the air inlet 302. The tip air passage 814 can be configured to align with a base air inlet 810, such as when the tip (e.g., or base) is rotated into the restricted configuration. In this implementation, the base air inlet 810 can be fluidly coupled with a base air outlet 808, through a base air passage 208. The base air outlet 808 can be configured to provide air to the nozzle tip passage 212 when the nozzle tip 110 is disposed in the restricted configuration. Further, for example, when the nozzle tip 110 is disposed in an unrestricted configuration, the base air outlet 808 may not be fluidly coupled with the tip fluid passage 212, and/or the tip air passage 814 may not be fluidly aligned with the base air inlet 810. In this example, air may not enter into the tip fluid passage 212.

In another aspect of a nozzle devised to adjust between higher and lower fluid flow rates while maintaining fluid flow in a smooth bore stream profile, the nozzle may have a fluid passage that comprises two pathways. In this aspect, the nozzle may be adjusted using a simple and routine motion (e.g., rotation) that can result in restriction of one of the two fluid flow pathways, thereby alternating between an open and restricted flow.

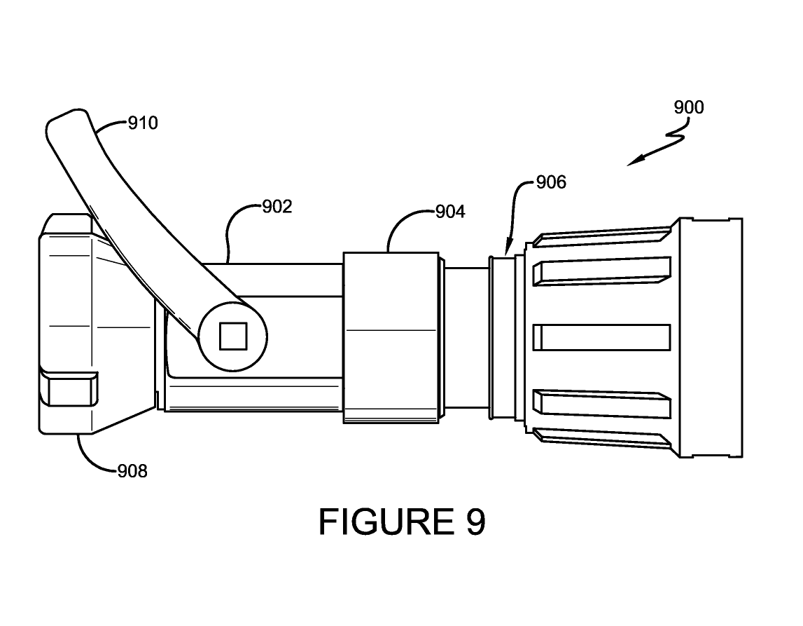

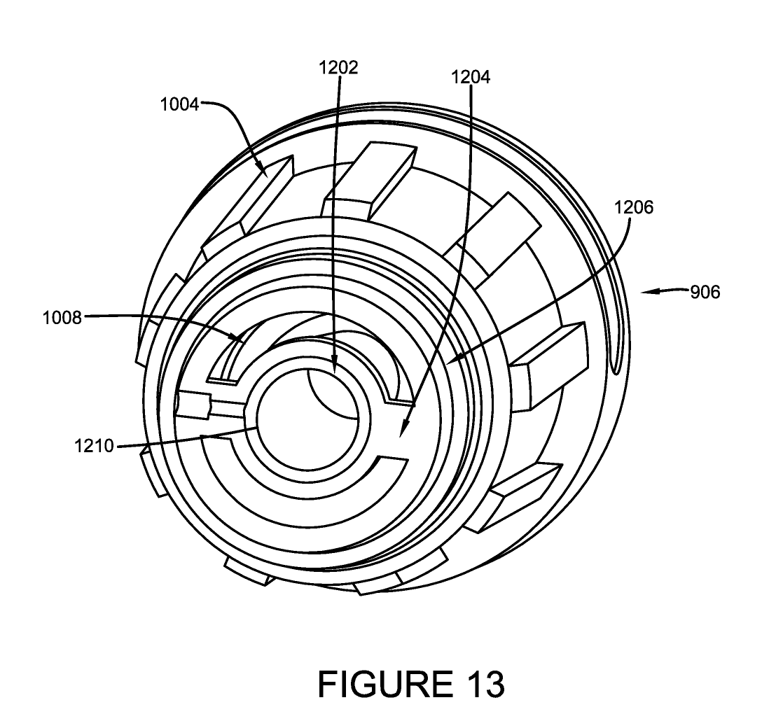

In one implementation, in this aspect, FIGS. 9-13 illustrate one or more portions of an example nozzle 900, which may provide a smooth bore fluid profile, and may be adjustable between a higher flow rate and lower flow rate. The example, nozzle 900 can comprise a fluid flow control body 902 operably coupled with a fluid inlet coupler 908. The fluid flow control body 902 can comprise a fluid flow control element 1002 coupled with a control actuator 910, which can be configured to control the fluid flow control element 1002. In one implementation, the control actuator 910, coupled with the fluid flow control element 1002, may be used to restrict (e.g., shut off) fluid flow 1010 for the nozzle 900, or open fluid flow 1010 for the nozzle 900. In another implementation, the control actuator 910 may cause the flow of fluid 1010 to be reduced through the nozzle 900, for example, by throttling the shutoff component fluid flow control element 1002 between an open and closed position.

As illustrated, the example, nozzle can comprise a nozzle base 904 (e.g., an adapter) and a nozzle tip 906. Further, the nozzle base 904 can be configured to selectably, operably couple with the fluid flow control body 902, and the nozzle tip 906 can be configured to selectably, operably couple with the nozzle base 904. Additionally, the nozzle base 904 can comprise a base fluid passage 1214, defined by a base passage wall 1212. In one implementation, the base fluid passage 1214 may be defined by a cone segment, with diverging walls in the direction of fluid flow 1010, for example. In another implementation, the nozzle tip 906 may be configured to operably couple directly with the fluid flow control body 902, for example, such that the nozzle base 904 may not be used. In another implementation, the nozzle base 904 may be fixedly engaged with (e.g., formed with or integral to) the nozzle tip 906. In this implementation, the combination nozzle base 904, nozzle tip 906 component can operably couple with the fluid flow control body 902.

In one implementation, the nozzle tip 906 can comprise a central fluid passage 1216 and an outer fluid passage 1218. For example, the nozzle tip 906 can be configured to separate the flow of fluid 1010 into two divergent flow streams 1010a, 1010b, which can subsequently converge into a single smooth bore fluid pattern at discharge from a flow control sleeve 1008. The nozzle tip 906 can comprise a stream separator 1012 configured to divide the fluid flow 1010 between the central fluid passage 1216 and the outer fluid passage 1218.

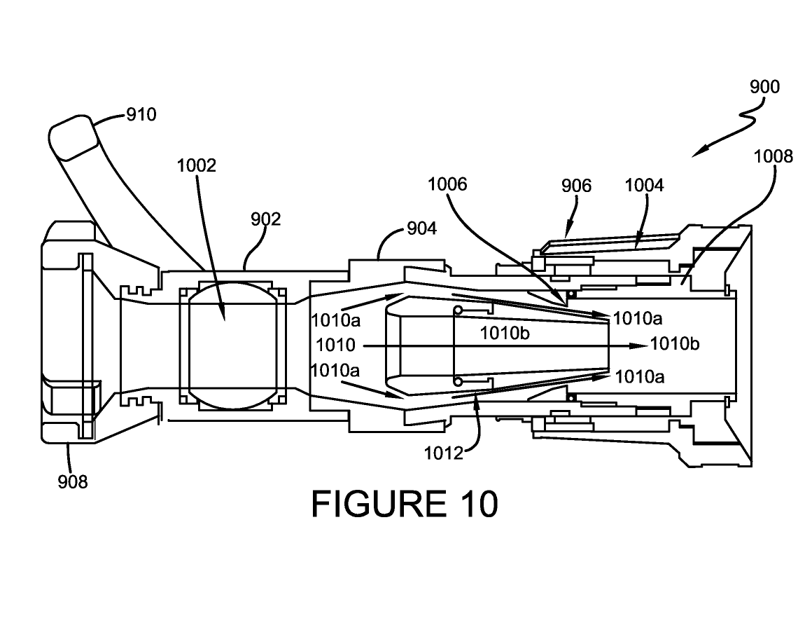

In one implementation, as illustrated in FIGS. 10-13, the stream separator 1012 can be fixedly engaged with a nozzle body 1204 portion of the nozzle tip 906. Further the stream separator 1012 can comprise a discharge tube coupler 1210, configured to selectably couple with a discharge tube 1202, which may be configured to provide a smooth bore stream pattern. In one or more implementations, a discharge tube 1202 may be selected for a desired stream profile, and/or a desired water inlet size. That is, for example, the discharge tube 1202 may be available in a variety of sizes configured to accommodate a desired fluid output (e.g., and/or fluid input) profile. As an example, typical firefighting nozzles are described by particular diameter size properties, such as ¾ inch, ⅞ inch, and 1⅛ inch, and more. In this example, in order to accommodate a same expected output as a particular size nozzle tip, the discharge tube 1202 can be sized accordingly (e.g., sized in combination with a size of the outer fluid passage 1218 to achieve the desired stream profile and output).

The stream separator 1012 coupled with the discharge tube 1202, forming the central fluid passage 1216, can be configured to provide a straight, smooth (e.g., smooth bore tip) fluid pattern at discharge of the fluid from the nozzle 900. The smooth bore tip can typically provide a generally straight pattern stream of fluid from the outlet of the nozzle. As an example, the straight bore, central fluid passage 1216 portion of the example nozzle 900 can comprise a generally straight tube configured to provide a straight path for fluid from inside the nozzle to an outlet portion of the nozzle, in the control sleeve 1008. In this way, pressurized fluid can be expelled from the nozzle in a generally straight stream pattern.

An upstream portion of the stream separator 1012 can comprise a tapered lip portion, tapering toward the upstream end, and diverging toward the outer fluid passage 1218. In combination with the divergent tapering base passage wall 1212, the tapered lip portion of the discharge tube coupler 1210 can form the beginning of the outer fluid passage 1218. The upstream portion of the stream separator 1012 can be configured to divert at least a portion of the fluid flow 1010 to the outer passage fluid flow 1010a. In this implementation, the downstream portion of the exterior of the stream separator 1012 and the discharge tube 1202 can comprise a convergent taper, converging toward the downstream end, which, along with the nozzle body 1204 and flow control sleeve 1008, form the downstream portion of the outer fluid passage 1218.

In one implementation, the angle of slope, amount of gap, and length of slope of the respective outer fluid passage 1218 (e.g., tapered lip portion of stream separator 1012, tapering base passage wall 1212, convergent taper of the downstream portion of the outer fluid passage 1218, and combination of the inner wall of the nozzle body 1204 and the flow control sleeve 1008) may help provide a desired fluid flow characteristic, such as flow rate, pressure, stream profile and more. As an example, the output flow fluid characteristic of the outer fluid passage 1218 may approximate the output fluid flow characteristics of the central fluid passage 1216 in order to provide a desired convergent straight stream profile at output from the nozzle.

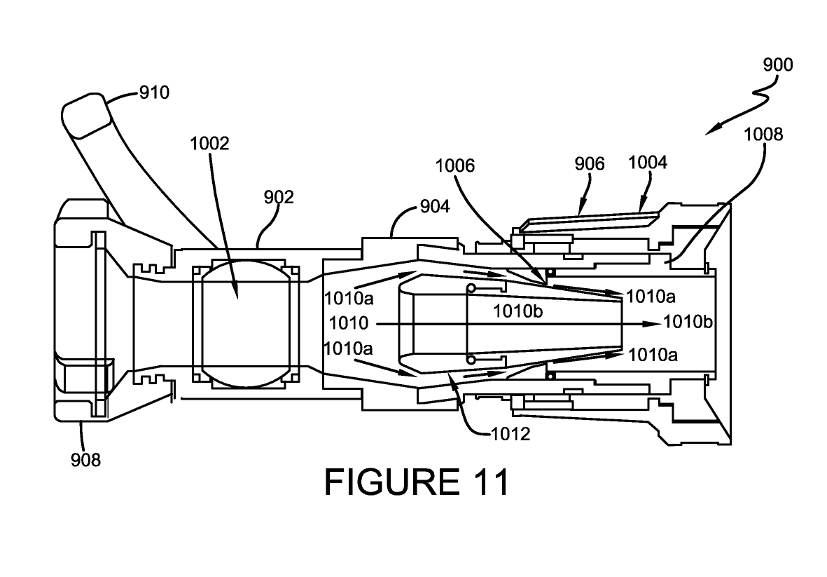

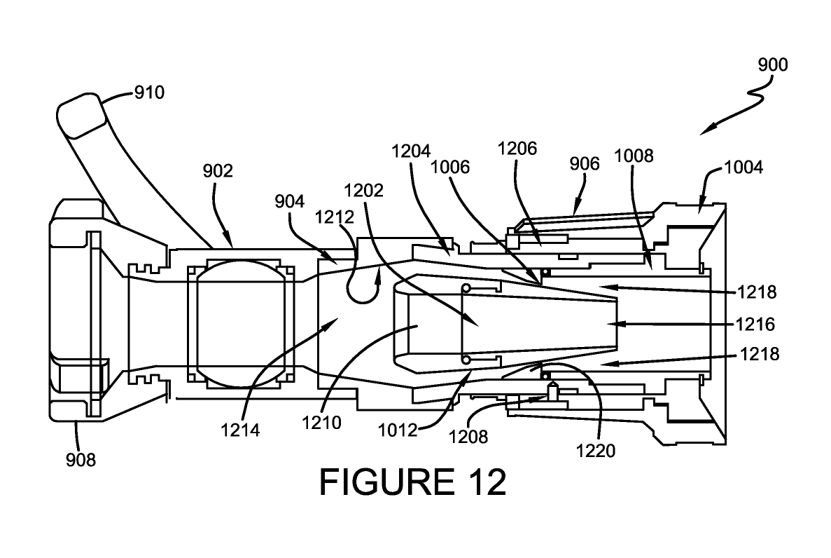

Further, in this implementation, the flow control sleeve 1008 comprises a restrictor component 1220 that is configured to define an outer fluid passage gap 1006. The restrictor component 1220 can comprise an extension of the flow control sleeve 1008, extending into the outer passage. For example, the disposition of the flow control sleeve 1008 relative to the nozzle body 1204 may, at least in part, define the fluid passage gap 1006. That is, for example, when the flow control sleeve 1008 is disposed in a forward position (e.g., FIG. 10), a gap 1006 between the restrictor component 1220 and the outer wall of the discharge tube 1202 may comprise a less restricted fluid flow (e.g., high flow rate). Additionally, in this example, when the flow control sleeve 1008 is disposed in a rearward position (e.g., FIGS. 11 and 12), the gap 1006 between the restrictor component 1220 and the outer wall of the discharge tube 1202 may comprise a more restricted fluid flow (e.g., low flow rate), essentially limiting fluid flow 1010a through the outer passage to the outlet. In this way, in this example, when the flow control sleeve 1008 is disposed in a rearward position, providing the restricted fluid flow, a lower fluid flow rate may be provided to the outlet of the nozzle 900, while maintaining a straight stream discharge pattern.

In one implementation, the flow control sleeve 1008 can be operably engaged with an outer sleeve 1206, which can act as a restrictor actuator, and can be further operably engaged with a bumper 1004 at the outer surface of the nozzle tip 906. Further, in this implementation, the nozzle body 1204 can be selectably engaged with the nozzle base 904 (e.g., which is engaged with the fluid flow control body 902). Additionally, the nozzle body 1204 can be slidably engaged with the flow control sleeve 1008, such that the flow control sleeve 1008 can slide forward and rearward (e.g., and rotate) with respect to the nozzle body 1204. That is, for example, the nozzle body 1204 can remain stationary relative to the nozzle base 904, while the flow control sleeve 1008 may translate forward and rearward, relative to the nozzle body 1204.

In one implementation, the outer sleeve 1206, acting as the restriction actuator, which is engaged with the flow control sleeve 1008, may be driven by a cam system 1208, comprising a cam insert that is configured to provide a particular distance of translation of the flow control sleeve 1008 when rotation (e.g., one-hundred and eighty degrees) is applied. That is, for example, the cam system 1208 may comprise a thread (e.g., spiral) pattern disposed on the nozzle body 1204 (e.g., with a lead or pitch for a single start thread) that provides for a desired flow control sleeve translation (e.g., desired distance forward and rearward), which can allow the flow control sleeve to more forward and rearward along the nozzle body, thereby adjusting a position of the restrictor component 1220, and therefore the gap 1006 in the outer fluid passage 1218.

In one implementation, the cam system 1208 can comprise a component that couples the outer sleeve 1206 to the nozzle body 1204, by way of a thread channel that is disposed in the nozzle body 1204. That is, for example, a cam insert may be engaged with the outer sleeve 1206 and may also be slidably engaged with the thread channel disposed on the exterior of the nozzle body 1204. In this implementation, the thread channel may be disposed around the perimeter of the nozzle body 1204 in a thread pattern (e.g., spiral pattern), comprising the desired thread lead (e.g., spiral pitch). In this example, when a rotational force is applied to the outer sleeve 1206, such as by rotating an attached bumper 1004 engaged with the outer sleeve 1206, the coupled cam insert can translate spirally in the thread channel to convert the rotational force into a lateral movement of the flow control sleeve 1008 with respect to the nozzle body 1204 and the discharge tube 1202.

As illustrated in FIGS. 10 and 11, in one implementation, rotating the outer sleeve 1206 can result in linear translation of the flow control sleeve 1008, for example, while the engaged discharge tube 1202 and nozzle body 1204 remain stationary. In this implementation, linear translation of the outer sleeve 1206 can change the gap 1006 between the restrictor component 1220 and discharge tube 1202, between a restricted (e.g., FIG. 11) and unrestricted (e.g., FIG. 10) configuration. In FIG. 10, the flow control element 1002 is disposed in an open position, allowing fluid flow 1010 from the inlet 908 into the example nozzle 900. The fluid flow 1010 is divided into the outer flow stream 1010a and central fluid low stream 1010b by the upstream portion of the discharge tube coupler 1210, comprising a diverging profile in combination with the base passage wall 1212. With the flow control sleeve 1008 disposed in the forward (e.g., or downstream) position, the restrictor component 1220 provides a less restricted gap 1006, allowing the fluid flow 1010a to converge with the central fluid flow 1010b at substantially a same flow rate and/or flow characteristic (e.g., speed, pressure, etc.), resulting in a substantially straight stream profile at a higher flow rate. In FIG. 11, the flow control sleeve 1008 is disposed in the rearward (e.g., or upstream) position, effectively, at least partially, restricting the outer fluid flow 1010a with the restrictor component 1220 creating a more restricted gap 1006 in combination with the discharge tube 1202. In this way, for example, the fluid flow from the nozzle 900 may merely comprise the central fluid flow 1010b in a straight stream profile at a lower flow rate.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A nozzle, comprising:
a fluid flow control body configured to control fluid flow into the nozzle;
a nozzle base operably coupled with the fluid flow control body, and comprising a base fluid passage;
a nozzle tip operably coupled with the nozzle base, and comprising a tip fluid passage in fluid communication with the base fluid passage, the tip fluid passage comprising a straight bore passage configured to provide a straight stream fluid discharge from an outlet of the nozzle disposed in an open position and in a restricted position; and
a restrictor component configured to restrict flow of fluid between the base fluid passage and the outlet of the nozzle when the nozzle is disposed in the restricted position; and
a restriction actuator operably coupled with the restrictor component, and configured to actuate the restrictor component between the open position and restricted position.

2. The nozzle of claim 1, the restrictor component comprising an interface orifice between the base fluid passage and the tip fluid passage configured to provide restricted flow at a non-alignment position of the base fluid passage and the tip fluid passage, and to provide unrestricted flow at an alignment position of the base fluid passage and the tip fluid passage.

3. The nozzle of claim 2, a central axis of the nozzle substantially parallel to the flow of fluid, and one of:
the restriction actuator comprising the nozzle tip configured to rotate around the central axis of the nozzle between the alignment position and the non-alignment position; and
the restriction actuator comprising the nozzle base configured to rotate around the central axis of the nozzle between the alignment position and the non-alignment position.

4. The nozzle of claim 2, the face of the base fluid passage and the face of the tip fluid passage at the interface orifice between the base fluid passage and the tip fluid passage respectively comprising a shape that results in restricted flow at the interface orifice when rotated into non-alignment and unrestricted flow when rotated into alignment.

5. The nozzle of claim 2, comprising an air inlet configured to introduce air into the fluid flow proximate the upstream end of the tip fluid passage when disposed in the non-alignment position.

6. The nozzle of claim 1, the restrictor component comprising an extension of a flow control sleeve extending into a first fluid passage of the nozzle tip, and configured to provide restricted flow in the first fluid passage in an upstream position and provide non-restricted flow in the first fluid passage in a downstream position.

7. The nozzle of claim 6, the nozzle tip comprising a second fluid passage comprising a centrally disposed straight bore passage defined by a discharge tube, and the first fluid passage comprising an outer fluid passage disposed between the discharge tube and the flow control sleeve.

8. The nozzle of claim 6, the nozzle tip comprising a stream separator disposed at the upstream end of the nozzle tip, and configured to separate the flow of fluid into an outer fluid flow to the first fluid passage and a straight fluid flow to a second fluid passage.

9. The nozzle of claim 8, the stream separator comprising a discharge tube coupler configured to selectably couple with a discharge tube, the discharge tube comprising the second fluid passage.

10. The nozzle of claim 6, the first fluid passage comprising a perimeter fluid flow converging downstream with a second fluid passage in the nozzle tip resulting in a straight stream discharge pattern from the nozzle tip, the second fluid passage.

11. The nozzle of claim 6, the restriction actuator comprising an outer sleeve operably coupled with the nozzle tip and configured to rotate around a nozzle body of the nozzle tip, resulting in translation of the flow control sleeve between the upstream position and the downstream position.

12. A nozzle system for dispensing fluid in a straight pattern stream, comprising:
a nozzle base configured to selectably, operably couple with a fluid flow control body, and comprising a base fluid passage defined by a cylinder having downstream face that comprises a first shape; and
a nozzle tip operably coupled with the nozzle base, and comprising a tip fluid passage defined by a cylinder having an upstream face that comprises the first shape, the base fluid passage fluidly coupled with the tip fluid passage at an interface orifice to form a nozzle fluid passage configured to provide a straight pattern stream;
the nozzle tip and nozzle base configured to rotate with respect to each other at the interface orifice, around a central axis of the nozzle system, between an alignment position and a non-alignment position, the alignment position providing substantially open fluid flow and comprising an alignment of the downstream face of the base fluid passage and the upstream face of the tip fluid passage at the interface orifice, the non-alignment position providing restricted fluid flow and comprising the downstream face of the base fluid passage and upstream face of the tip fluid passage disposed in a non-alignment position at the interface orifice.

13. The system of claim 12, comprising an air inlet configured to introduce air into the fluid flow proximate the upstream end of the tip fluid passage when disposed in the non-alignment position.

14. The system of claim 13, the air inlet comprising a check valve configured to merely allow air to flow into the nozzle tip.

15. The system of claim 13, comprising an air passage disposed between the air inlet and the interface orifice, the air inlet disposed in the nozzle tip, and at least a portion of the air passage disposed in the nozzle base.

16. The system of claim 12, the first shape comprising one of:
an ellipse;
a polygon;
a curved polygon;
an non-circle.

17. A nozzle device that dispenses fluid in a straight pattern stream, comprising:
a nozzle base comprising a base fluid passage defined by a cone-shaped wall diverging downstream, and configured to selectably couple with a shutoff body; and
a nozzle tip configured to operably couple with the nozzle base, and to separate fluid flow from the nozzle base into an outer fluid stream and a central fluid stream, and to merge the separated streams into a substantially straight stream, the nozzle tip comprising:
a stream separator engaged with a nozzle body, and configured to separate the fluid flow into the outer fluid stream and the central fluid stream, the stream separator comprising a lip portion tapering toward the upstream end;
a discharge tube selectably coupled with the stream separator, and configured to direct the central fluid stream to a flow control sleeve, and comprising an outside surface tapering toward the downstream end; and
a flow control sleeve configured to slidably translate between a forward and rearward position with respect to the nozzle body, and comprising a restrictor in the rearward position configured to restrict the outer fluid stream in conjunction with the outside surface of the discharge tube, and to provide a substantially unrestricted outer fluid stream flow in the forward position.

18. The device of claim 17, comprising an outer sleeve operably coupled with the nozzle tip and configured to rotate around the nozzle body, resulting in translation of the flow control sleeve between the forward position and the rearward position.

19. The device of claim 18, comprising a cam system configured to translate a rotational motion of the outer sleeve into a linear motion of the flow control sleeve.

20. The device of claim 17, the flow control sleeve comprising a substantially straight bore passage extending between the downstream end of the discharge tube and an outlet of the nozzle, and configured to receive the merged outer fluid stream and central fluid stream and provide a straight stream pattern at the outlet of the nozzle in both a restricted and unrestricted flow position.
